(19) United States
(12) Patent Application Publication
(10) Pub. No.: US 2017/0095068 A1
(43) Pub. Date: Apr. 6, 2017

(54) TOOL HOLDER FOR T-SHAPED TOOLS

(71) Applicant: TY-FLOT, INC., Manchester, NH (US)

(72) Inventors: Darrell A. Moreau, Manchester, NH (US); Andre W. Moreau, Bedford, NH (US)

(73) Assignee: TY-FLOT, INC., Manchester, NH (US)

(21) Appl. No.: 14/875,203

(22) Filed: Oct. 5, 2015

(51) Int. Cl. A45F 5/02; F16M 13/02; B25H 3/04

(52) U.S. Cl. CPC A45F 5/021; B25H 3/04; F16M 13/02; A45F 2200/0575

(57) ABSTRACT

A tool holder for T-shaped tools includes a holder body having left and right holder arms extending forward from a holder body in a spaced apart relation to support a tool by the tool head. Each holder arm generally defines a U shape. The left arm end and the right arm end are spaced apart from each other, defining a fixed gap for passage of a tether connected to the tool handle.

### BACKGROUND OF THE INVENTION

1. Field of the Invention

The present invention relates generally to tool accessories and more particularly to a holder for T-shaped tools such as, for example, hammers, scaffold wrenches, hatchets, and the like.

2. Description of the Prior Art

Carpenters, facilities maintenance personnel, and other workers often use a hammer or mallet on the job. For workers who assemble scaffolding and other industrial equipment, the worker also frequently carries a scaffolding wrench. Woodsmen and other workers use a hatchet or axe as part of their job. In common to tools of this type is an elongated handle connected to a tool head, where the tool generally has a T shape. Tools having a T-shaped handle, such as a water valve wrench or T-shaped hex key, are also considered in this category of T-shaped tools.

Hammers and related tools traditionally are attached to the worker by passing the handle of the tool through a loop on a carpenter's belt or the like. For example, some carpenter's belts have a metal ring that attached to the belt and extending from the belt in a horizontal orientation. The user inserts the handle of the hammer through the opening of the ring so that the ring supports the head of the tool. A hammer or the like can similarly be stored using a leather or cloth loop attached to the tool belt.

To facilitate inserting the tool into the holder, one company has developed a gated hammer holder for hammers, hatchets, scaffolding wrenches and the like. The gated hammer holder modifies the metal ring holder by adding a gated opening of the front of the ring. Rather than a continuous metal bar across the front, the gated hammer holder has two arms that extend out from the belt and turn towards each other, where each arm end has a pivoting gate device. The gate devices open by pivoting inward only. Therefore, the user may put the tool into the holder by pressing the handle through the gate devices rather than having to insert the handle downward through the opening of the holder.

### SUMMARY OF THE INVENTION

Prior art designs for holders for T-shaped tools generally do not contemplate use of the holder when a tether or safety lanyard is attached to the handle of the tool. Prior art holders also lack a mechanism to prevent the tool from being inadvertently knocked out of the holder, such as when the handle contacts an object that pushes the handle up through the holder.

Therefore, what is needed is an improved design for a tool holder for hammers, scaffolding wrenches, and the like.

It is another object of the present invention to provide a tool holder designed to hold hammers, scaffolding wrenches, and like tools having a T shape.

It is another object of the present invention to provide a tool holder that facilitates use of the tool with the tool holder when a safety lanyard is connected to the tool.

The present invention achieves these and other objectives by providing a tool holder for hammers and like tools having a handle and a tool head, where the tool holder has a frame with a first arm and a second arm, and where the ends of each arm are spaced from each other to define an opening.

In one embodiment, the tool holder has a left holder arm and a right holder arm each extending from a holder midpoint to a respective left arm end and right arm end. The left holder arm includes a first left arm portion extending laterally away from the holder midpoint, a second left arm portion joined continuously with the first left arm portion at a left rear shoulder portion and generally defining a U shape that extends forward from the left rear shoulder portion, and a third left arm portion joined continuously with the second left arm portion at a left forward shoulder portion. The third left arm portion extends generally laterally from the first forward shoulder portion to terminate at the left arm end, where the third left arm portion is spaced apart from the first left arm portion. The right holder arm is connected to the left holder arm at the holder midpoint and is similar to the left holder arm.

The right holder arm includes a first right arm portion extending laterally away from the holder midpoint in a direction generally opposite of the first left arm portion. A second right arm portion is joined continuously with the first right arm portion at a right rear shoulder portion. The second right arm portion generally defines a U shape that extends forward from the right rear shoulder portion. A third right arm portion is joined continuously with the second right arm portion at a right forward shoulder portion, where the third right arm portion extends generally laterally from the right forward shoulder portion to terminate at the right arm end and where the third right arm portion is spaced apart from the first right arm portion. The left arm end and the right arm end are discontinuous and spaced apart from each other to define a gap. The left holder arm and the right holder arm extend in spaced apart relation to define a tool opening sized to accept a tool handle vertically therethrough with the tool head being supported by the left holder arm and the right holder arm.

In another embodiment, the holder defines an opening aligned with the holder midpoint and the tool holder is configured to be supported by and pivot about a fastener extending through the opening.

In another embodiment, the left holder arm defines a left rear cord opening, the right holder arm defines a right rear cord opening, and the tool holder includes a cord member extending through the left rear cord opening and the right rear cord opening. The cord member defines an open or closed loop with an adjustable size. In some embodiments, the cord member includes a pull tab.

In another embodiment, the left rear cord opening is defined by the left rear shoulder portion and the right rear cord opening is defined by the right rear shoulder portion. For example, the left rear shoulder portion and the right rear shoulder portion each have a spiral that defines the respective left rear cord opening and the right rear cord opening.

In another embodiment, the third left arm portion and the third right arm portion each defines a catch sufficient to engage and retain the cord member extended forward from the left rear cord opening and the right rear cord opening. The catch may be the result of the shape of the third arm portion or a feature on the third arm portion, such as a hook.

In another embodiment, the tool holder has a holder body, a left holder arm extending forwardly from the holder body to a first arm end and generally defining a left U shape, and a right holder arm extending forwardly from the holder body to a second arm end and generally defining a right U shape. The right holder arm is spaced apart from the left holder arm to define a tool opening sized to accept a tool handle vertically therethrough with the tool head being supported by the left holder arm and the right holder arm. The left arm end and the right arm end are spaced apart from each other to define a gap communicating with the holder opening to permit ingress and egress of a lanyard attached to the tool handle.

In another embodiment, the tool holder includes a cord member attached to the holder body and defining a loop with an adjustable size. The tool holder also includes a left catch on the left holder arm and a right catch on the right holder arm. The left catch and the right catch are sized and configured to engage and retain the loop extending forward from the holder body.

In another embodiment, the left catch is defined by the left holder arm turning from the U shape and extending downwardly to the left arm end. Similarly, the right catch is defined by the right holder arm turning from the right U shape and extending downwardly to the right arm end.

In some embodiments, the left holder arm and the right holder arm are substantially symmetrical. In other embodiments, the left and right holder arms are asymmetrical to accommodate tools with tool head portions of unequal size.

In another embodiment, the holder body defines a left cord opening and a right cord opening, where the cord member is attached to the holder body through the left cord opening and the right cord opening. In some embodiments, the cord member is made of a resilient material, such as silicone rubber. In other embodiments, the cord member is made of a length of cord, string, rope, leather, or cable.

In some embodiments, a pull tab is connected to the loop of the cord member.

In another embodiment, the tool holder includes a hanger member configured to interface with the holder body, a fastener coupling the holder body to the hanger member, and a hanger catch on the hanger member configured to engage the loop and retain the cord member in a stowed position.

Another aspect of the invention is directed to a method of storing a tethered tool. In one embodiment, the method includes the steps of providing a tool with a handle extending transversely from a tool head, where the tool head defines a first tool head portion and a second tool head portion extending in generally opposite directions from each other, and where the tool includes a tether attached to the handle; providing a tool holder having a left holder arm and a right holder arm each extending laterally and then forward of a holder midpoint to a respective left arm end and a right arm end, where the left holder arm and the right holder arm each define a U shape that extends forward in a spaced apart relation from the holder midpoint, where the left holder arm and the right holder arm define a tool opening vertically through the tool holder, and where the left arm end and right arm end are discontinuous and define a gap therebetween; inserting the handle through the tool opening; passing the tether through the gap between the left arm end and the right arm end; and placing the tool head on the left holder arm and the right tool holder arm, thereby supporting the tool by the tool holder.

In other embodiments of the method, providing the tool holder includes selecting the tool holder to include a cord member connected through right and left cord openings defined by the tool holder, where the cord member defines a loop of adjustable size; extending the cord member forward from the right and left cord openings to loop over the right arm end and the left arm end; and changing the adjustable size to retain the cord member extending forward over the tool head.

In another embodiment, the method also includes the steps of disengaging the cord member from the right arm end and the left arm end; lifting the tool upward through the tool opening; and passing the tether out through the gap between the right arm end and the left arm end.

In another embodiment of the method, the step of selecting the tool holder to include a cord member includes selecting the cord member made of a stretchable material, where changing the adjustable size includes allowing the stretchable material to assume a tightened state against the tool holder.

In another embodiment, the method also includes selecting the tool holder to include a hanger member having a cord catch configured to engage the cord member, and positioning the cord member to engage the cord catch, thereby placing the cord member in a stowed position.

### BRIEF DESCRIPTION OF THE DRAWINGS

FIG. 1 is a perspective view of one embodiment of a tool holder of the present invention showing a tool, a hanger member, and a tool belt.

FIG. 2 is a perspective view of the tool holder of FIG. 1 showing the tool holder separated from the hanger member.

FIG. 2A is a perspective view of an embodiment of a tool holder showing a cord member with cord lock connected to the tool holder.

FIG. 2B is a rear elevational view of an embodiment of a tool holder showing a gap between turns of the coil formed at rear shoulder portions of the tool holder.

FIG. 3 is a front elevational view of the tool holder of FIG. 1 showing part of a tool handle with attached tether.

FIG. 4 is a rear elevational view of the tool holder of FIG. 1.

FIG. 5 is a left-side elevational view of the tool holder of FIG. 1 showing a cord member extending across the open receptacle space.

FIG. 6 is a right-side elevational view of the tool holder of FIG. 1 showing a cord member disengaged from the right and left end portions and suspended from right and left rear cord openings.

FIG. 7 is a top plan view of the tool holder of FIG. 1.

FIG. 8 is a bottom plan view of the tool holder of FIG. 1.

FIG. 9 is a right and front perspective view showing another embodiment of a tool holder of the present invention with a cord member and hanger member, where the components are shown separated from one another.

FIG. 9A is a right and front perspective view of the components of FIG. 9 shown assembled.

FIG. 10 is a right and rear perspective view of the tool holder of FIG. 9 showing the tool holder, cord member and hanger member separated from one another.

FIG. 10A is a right and rear perspective view of the components of FIG. 10 shown assembled.

FIG. 11 is a top plan view of one embodiment of a cord member of the present invention showing the cord, front plate, and rear plate.

FIG. 12 is a right-side elevational view of the tool holder of FIG. 9A with cord member and hanger member, where the hanger member is shown aligned with the body top portion.

FIG. 13 is a left-side elevational view of the tool holder of FIG. 9A showing the cord member engaging the cord catch of the hanger member.

FIG. 14 is a front elevational view of the tool holder and cord member of FIG. 9A.

FIG. 15 is a rear elevational view of the tool holder and cord member of FIG. 9A.

FIG. 16 is a top plan view of the tool holder and cord member of FIG. 9A.

FIG. 17 is a bottom plan view of the tool holder and cord member of FIG. 9A.

FIG. 18 is a right and front perspective view of the tool holder and cord member of FIG. 9A shown in use with a T-shaped tool, where the cord member extends from the holder body to engage the left and right catches.

### DETAILED DESCRIPTION

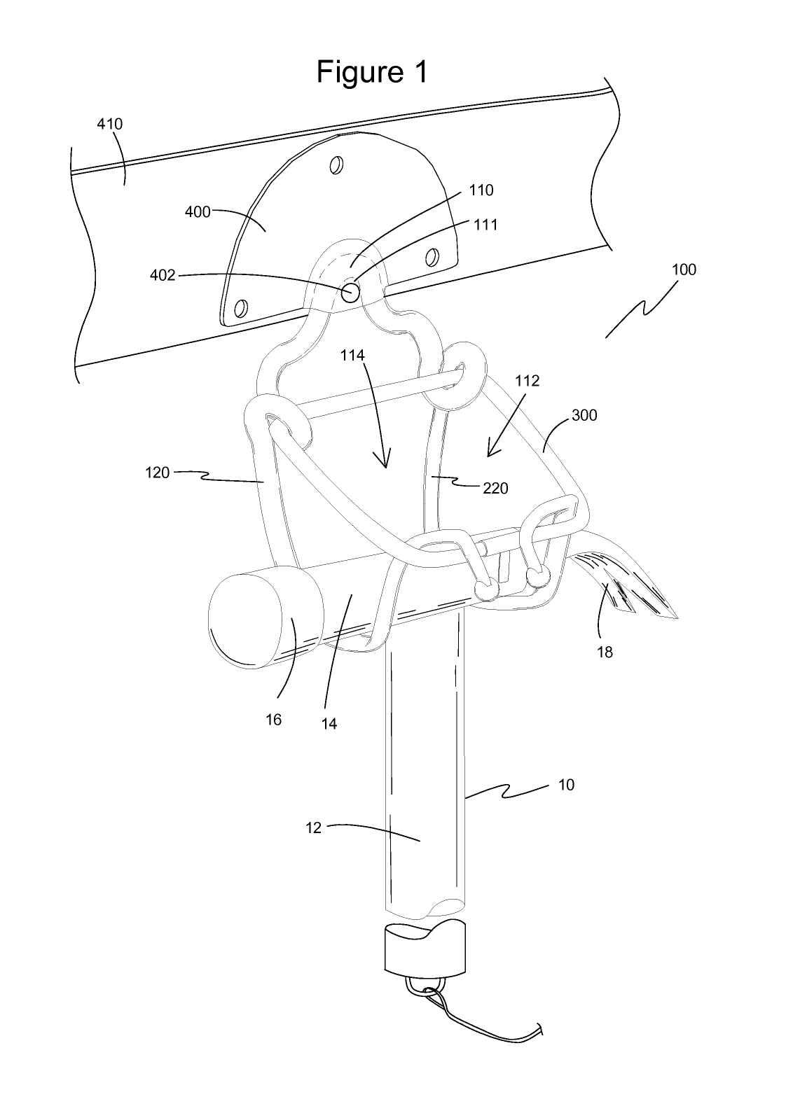

The preferred embodiments of the present invention are illustrated in FIGS. 1-18. FIG. 1 illustrates a front perspective view of one embodiment of a tool holder 100 for a tool 10 having a handle 12 extending down from a tool head 14. Although a hammer is illustrated, it is contemplated that any T-shaped tool may be supported by tool holder 100. Tool holder 100 has a left holder arm 120 and a right holder arm 220 each extending from a holder body 108 to define an open receptacle space 112 with a tool opening 114 sized to receive a handle 12 of tool 10 extending vertically therethrough. As is typical for T-shaped tools, tool head 14 has a first tool head portion 16 and a second tool head portion 18 extending in generally opposite directions from handle 12. Tool holder 100 typically supports tool 10 with first tool head portion 16 and second tool head portion 18 each in contact with respective left and right holder arms 120, 220 and with handle 12 extending through tool opening 114.

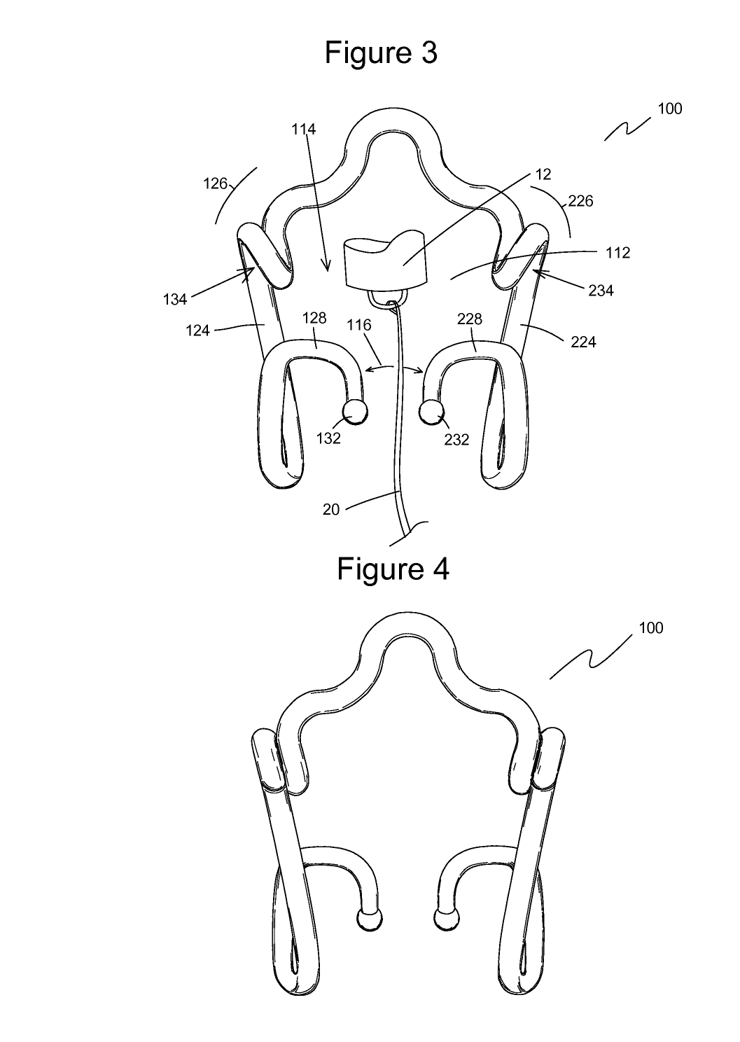

As used herein, the directional terms “right,” “left,” “forward,” “backward,” “front,” “rear,” “lateral,” “up,” “down,” and the like are used to describe tool holder 100 as viewed in a front elevational view as in FIG. 3, and do not limit embodiments of tool holder 100 to this specific orientation.

Tool holder 100 in one embodiment is configured to attach to a hanger member 400 that may be secured to the user's tool belt 410 or other object. In some embodiments, tool holder 100 is made of metal or other rigid material. In some embodiments, tool holder 100 defines an opening 111 at or near a holder midpoint 110, where tool holder 100 is configured to be supported by and pivot about a fastener 402 extending through opening 111. Opening 111 may have an open geometry (e.g., an arch) or a closed geometry (e.g., a hole) as necessary to attach tool holder 100 to tool belt 410 or the like. For example, a rivet or other fastener 402 extends through opening 111 to secure tool holder 110 to hanger member 400 and tool belt 410. In some embodiments, tool holder 100 is provided in combination with tool belt 410 and/or hanger member 400.

Optionally, a cord member 300 is included that may be extended or stretched across tool holder 100 to prevent tool 10 from being inadvertently bumped or pushed out of tool holder 100. Cord member 300 is discussed in more detail below.

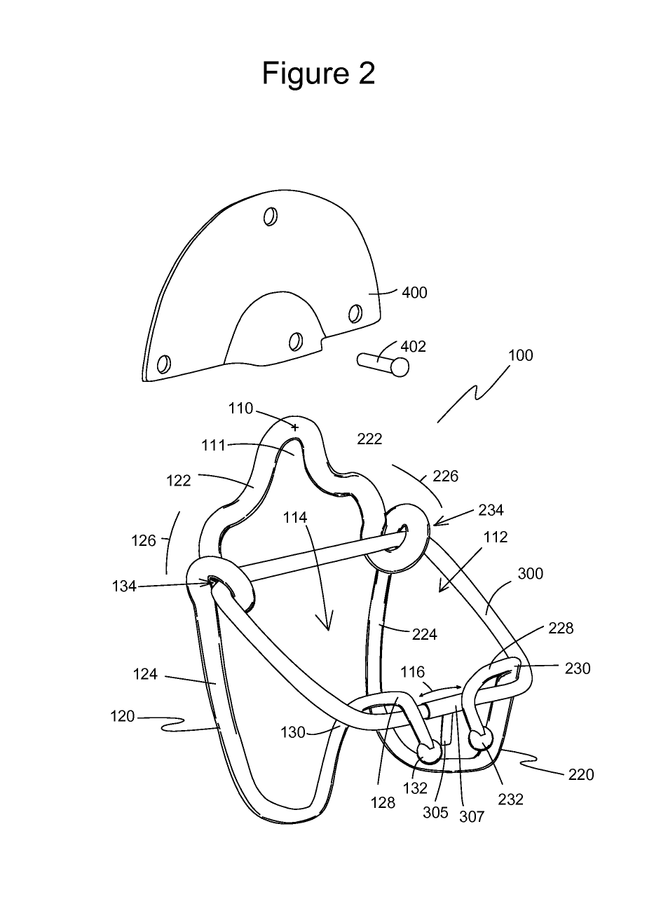

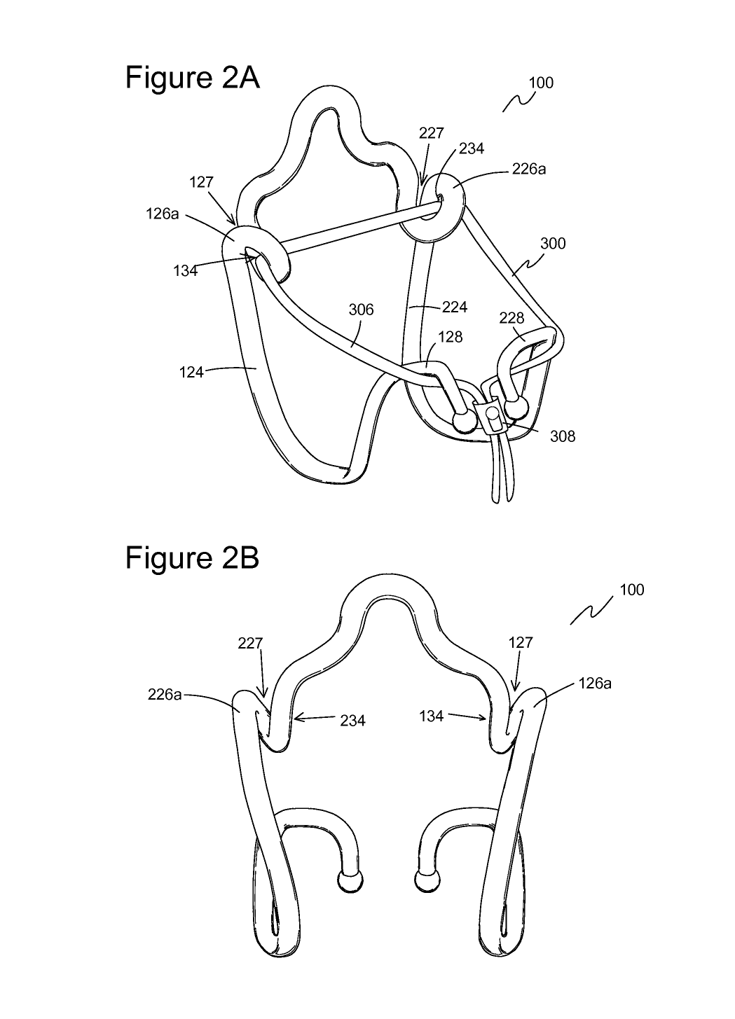

Referring now to FIG. 2, a perspective view illustrates tool holder 100 separated from hanger member 400. Holder body 108 defines an opening 111 aligned with holder midpoint 110 between left holder arm 120 and right holder arm 220. As shown, opening 111 is an open arch. Left holder arm 120 has a first left arm portion 122 connected to holder body 108 and extending laterally away from the holder midpoint 110. A second left arm portion 124 is joined continuously with and extends from first left arm portion 122 at a left rear shoulder portion 126. Second left arm portion 124 generally has a U shape or J shape and extends forward of left rear shoulder portion 126. A third left arm portion 128 is joined continuously with and extends from second left arm portion 124 at a left forward shoulder portion 130. Third left arm portion 128 extends generally laterally from the first forward shoulder portion 130 and terminates at a left arm end 132. Third left arm portion is spaced apart (i.e., forward) from the first left arm portion 122 and/or holder body 108, which is generally positioned against the user or the user's tool belt 410 (shown in FIG. 1).

Similarly, right holder arm 220 is connected to the left holder arm at the holder body 108 and extends to a right arm end 232. In some embodiments, right holder arm 220 is symmetrical and substantially identical to left holder arm 120. In other embodiments, right holder arm 220 differs from left holder arm 120 as needed for tool holder 100 to accommodate a specific tool or tools.

A first right arm portion 222 extends laterally away from holder midpoint 110 and in a generally opposite direction of first left arm portion 122. A second right arm portion 224 joins continuously with and extends from first right arm portion 222 at a right rear shoulder portion 226. Second right arm portion generally has a U shape or J shape. Second right arm portion 224 extends forward from right rear shoulder portion 226. Second right arm portion 224 is spaced apart from second left arm portion 124, where second left and right arm portions 124, 224 together define a cradle to support tool 10. A third right arm portion 228 is joined continuously with second right arm portion 224 at a right forward shoulder portion 230 with third right arm portion extending laterally towards third left arm portion 128. Third right arm portion terminates at right arm end 232. Third right arm portion 228 is spaced apart from first right arm portion 128, such as at arm ends 232, 132, respectively, to define a gap 116 or passageway into receptacle space 112. Since left holder arm 120 and right holder arm 220 are made of rigid materials, such as steel, gap 116 is generally fixed in size. Also, steel and similarly rigid materials result in third left and right arm portions 128, 228 that are substantially not pivotable, not movable, and not bendable relative tool holder 100 as a whole.

In one embodiment, tool holder 100 is a continuous length of material extending from left arm end 132 to right arm end 232 and bent or formed to define the various portions in between. In other embodiments, tool holder 100 is assembled from separate pieces that are fastened together. In yet other embodiments, first left arm portion 122 and first right arm portion 222 are part of holder body 108.

In one embodiment, tool holder 100 defines a left cord opening 134 and a right cord opening 234. In one embodiment, left rear shoulder portion 126 is a spiral that defines left cord opening 134 as the space through the spiral. In some embodiments, left cord opening 134 is formed through a tab or flattened region at left rear shoulder portion or along first or second left arm portion 122, 124. In other embodiments, left cord opening 134 is defined by a loop or hook extending from first or second left arm portion 122, 124 or at left rear shoulder portion 226. Right cord opening 234 may be similarly defined.

In one embodiment, each of third left arm portion 128 and third right arm portion 228 defines a catch sufficient to engage and retain cord member 300 when it is extended across tool opening 114 from the left and right cord openings 134, 234. For example, left arm end 132 and right arm end 232 are directed forward and somewhat downward from third left and right arm portions 128, 228, respectively. When left arm end 132 and right arm end 232 are positioned vertically below left cord opening 134 and right cord opening 234, left arm end 132 and right arm end 232 are positioned to function as a catch for cord member 300.

In one embodiment, tool holder 100 includes cord member 300 secured through left cord opening 134 and right cord opening 234. Cord member 300 may be a closed loop of stretchable, elasticized material or a strap or cord defining an open or closed loop with an adjustable size. For example, cord member 300 is a closed loop elastic band, a length of paracord with a cord lock for the ability to adjust the size to snugly engage tool holder 100, or a strap with a slider buckle for the ability to adjust the size to snugly fit to tool holder 100. FIG. 2A illustrates an example of tool holder 100 with cord member 300 as a length of paracord extending through left and right rear cord openings 134, 234. Ends of the paracord extend through cord lock 308 to adjust the size of loop 306

When cord member 300 is a length of material, its ends may be tied or otherwise secured to respective left and right cord openings 134, 234. When cord member 300 defines a permanently closed loop 306, however, it is still desirable to extend the loop through left and right cord openings 134, 234. In one embodiment, left rear shoulder portion 126 and right rear shoulder portion 226 define a spiral or coil 126a, 226a with a pitch great enough to permit passage of cord member 300 between adjacent turns of the spiral 126a, 226a. That is, spiral or coil 126a, 226a has a coil gap 127, 227 between adjacent turns of spiral 126a, 226a, respectively, that enables cord member 300 to be installed through left and right cord openings 134, 234. The coil gap 127, 227 is also shown in a rear elevational view of tool holder in FIG. 2B. Thus, as shown in FIGS. 2A and 2B, cord member 300 can be installed between adjacent turns of the spiral 126a, 226a so that it extends through left and right cord openings 134, 234 defined by the spirals and is removable even when it defines a permanently closed loop 306.

Alternately, for example, where the spiral 126a, 226a does not have sufficient space between adjacent turns, cord member 300 is a length of cord that may be fed directly through left and right cord openings 134, 234 defined by the spirals 126a, 226a and then the ends of the cord are passed through a cord lock to define a closed loop of adjustable size. Thus, various configurations enable cord member 300 to be removably attached to tool holder 100.

Whether made of a stretchable or non-stretchable material, cord member 300 has a loop of adjustable size that can extend forward from left and right cord openings 134, 234 to engage left and right holder arms 120, 220, such as at third left arm portion 128 and third right arm portion 228. In doing so, cord member 300 extends across the U shape or J shape of second left and right arm portions 124, 224. When cord member 300 is made of a stretchable material, cord member is sized to extend in tension while engaging third left and right arm portions. When cord member 300 is made of a non-stretchable material, such as paracord, cord member 300 may be pulled tight around third left and right arm portions 128, 228 and held in this position by a cord lock 308. When extended forward across tool holder 100 as described above, cord member 300 prevents tool 10 from being inadvertently removed from tool holder 100 by extending over tool head 14 and blocking upward egress of tool 10 from tool holder 100.

In one embodiment, cord member 300 includes an attached pull tab 305 to facilitate gripping and positioning cord member 300. In one embodiment, pull tab 305 is part of a union coupler or sleeve 307 disposed on cord member 300.

Referring now to FIG. 3, a front elevational view illustrates tool holder 100 of FIG. 1. Left and right cord openings 134, 234 have about the same vertical position and are both positioned vertically higher than left arm end 132 and right end 232. Left arm end 132 and right arm end 232 also have about the same vertical position. Since left arm end 132 and right arm end 232 extend forward and downward, cord member 300 (shown in FIG. 2) can be retained in a tensioned position by looping over left arm end 132 and right arm end 232. To facilitate ingress of handle 12 (shown in FIG. 1) into tool opening 114, and to also reduce the range of movement to tool 10 when supported by tool holder 100, second left and right arm portions 124, 224 in one embodiment generally extend inward towards each other as they extend downward from left rear shoulder portion 126 and right rear shoulder portion 226, respectively. Optionally, left arm end 132 and right arm end 232 have a rounded or ball shape to prevent snagging cord member 300 and to prevent injury to the user.

As tool 10 is placed into or lifted out of tool holder 100, gap 116 between third left and right arm portions 128, 228 permits a tether 20 attached to handle 12 to pass into and out of open receptacle space 112 of tool holder 100. FIG. 4 illustrates a rear elevational view of one embodiment of tool holder 100.

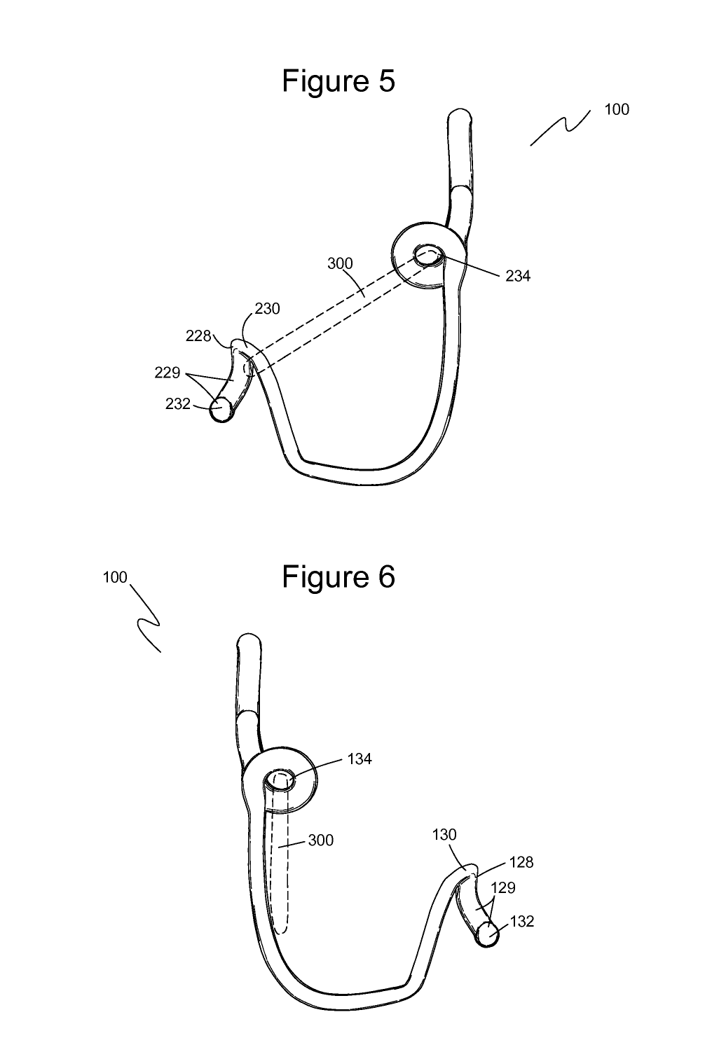

Referring now to FIGS. 5-6, right-side and left-side elevational views, respectively, illustrate one embodiment of tool holder 100. Right cord opening 234 and left cord opening 134 are aligned with each other as viewed from the side. Third left and right arm portions 128, 228 are also aligned with each other as viewed from the side. As shown, third left and right arm portions 128, 228 turn and extend forward and down from forward shoulder portions 130, 230 and extend to left and right arm ends 132, 232, respectively. This downward and forward portion of third left and right arm portions 128, 228 define left catch 129 and right catch 229, respectively. This downward and forward configuration facilitates hooking cord member 300 over third left and right arm portions 128, 228. It is contemplated that left and right arm portions 128, 228 do not need to extend forward. These configurations allow cord member 300 to be maintained at tension between left and right cord openings 134, 234 and left and right catches 129, 229 as shown in dashed lines in FIG. 5. Alternately, as shown in FIG. 6, cord member may be removed from third left and right catches 129, 229 and allowed to hang freely from left and right cord openings 134, 234 where it is out of the way to permit tool 10 to be removed and replaced from tool holder 100.

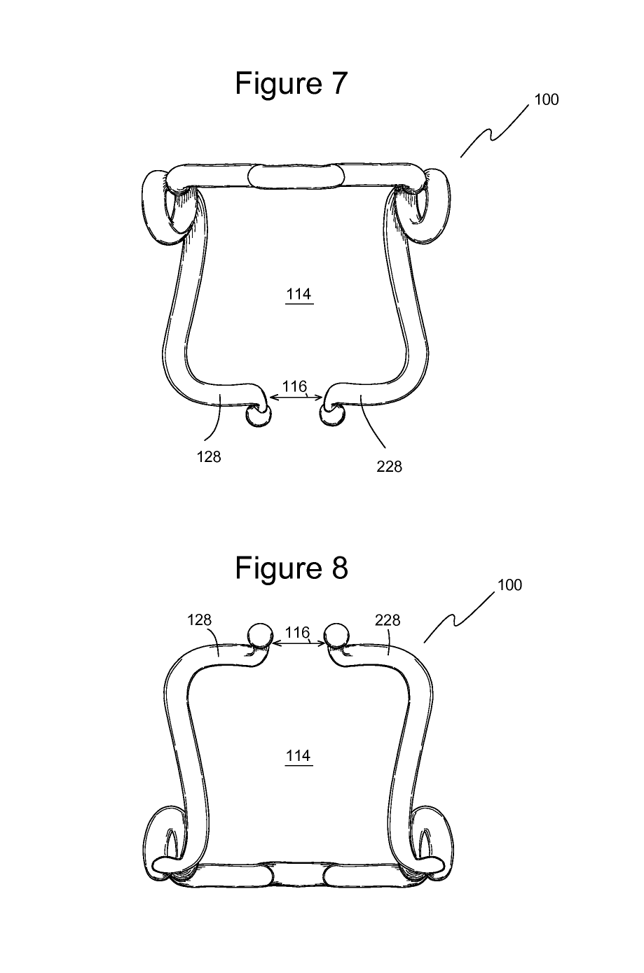

FIGS. 7 and 8 illustrate top and bottom plan views, respectively, of tool holder 100 showing tool opening 114 therethrough and gap 116 between third left and right arm portions128, 228, respectively. As shown in plan view, tool opening 114 has a substantially rectangular shape; however, other shapes are acceptable and may be selected based on the shape of handle 12 (shown in FIG. 1.)

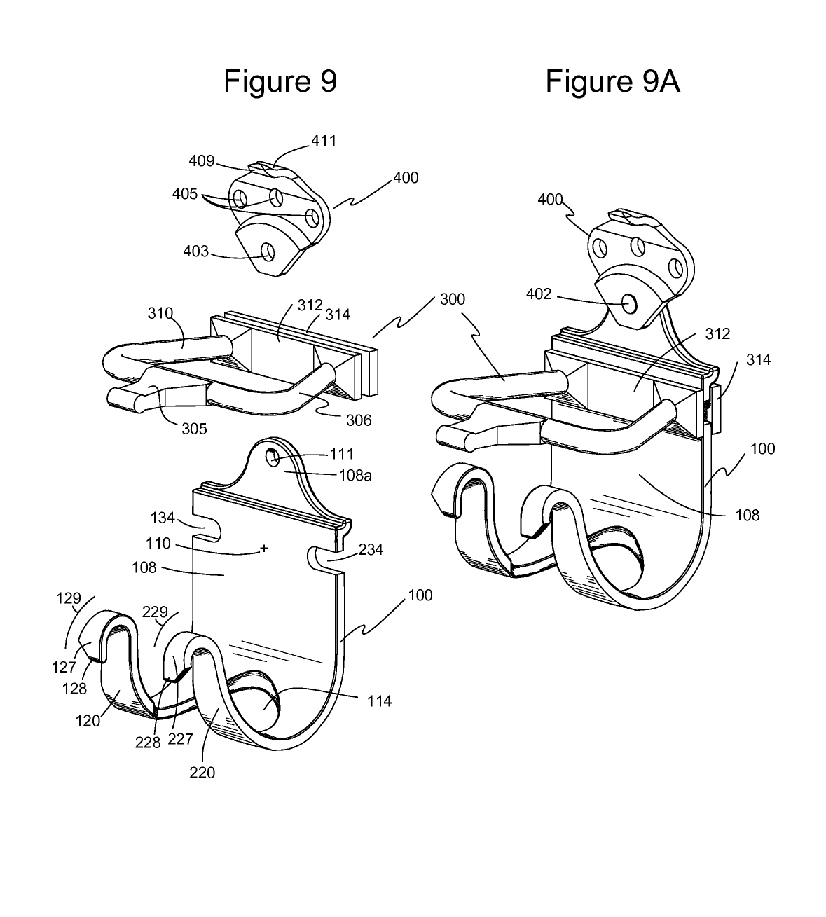

Referring now to FIGS. 9 and 9A, a left-side and front perspective view illustrates another embodiment of tool holder 100 with hanger member 400 and cord member 300. FIG. 9 illustrates the separate components; FIG. 9A illustrates the components assembled for use. The embodiment of tool holder 100 shown here may be made of sheet metal, such as ⅛″-thick steel or aluminum. For example, the shape and openings of tool holder 100 are formed or cut into a sheet of metal, then bent to define the U shape of the left and right holder arms 120, 220.

Similar to other embodiments of tool holder 100 discussed above, the embodiment of FIGS. 9-9A includes a holder body 108 with a holder midpoint 110. As shown, holder body 108 is a vertical plate extending from a body top portion 108a down toward the edge of tool opening 114. Left and right holder arms 120, 220 extend forward from holder body 108 in a spaced-apart relation to define tool opening 114. Left and right holder arms 120, 220 generally have a U shape or J shape to support tool 10 with handle 12 extending vertically through tool opening 114. Left arm end portion 127 curves downward from the U shape of left holder arm 120 to define left catch 129. Similarly, right arm end portion 227 curves downward from the U shape of right holder arm 220 to define right catch 229.

Holder body 108 defines left cord opening 134 and right cord opening 234 for attachment of cord member 300. Here, left and right cord openings 134, 234 are slots extending through holder body 108. Holder body 108 also defines opening 111, aligned with holder midpoint 110 for attachment to hanger member 400. In one embodiment, opening 111 is a hole in body top portion 108a.

In one embodiment, cord member 300 is made of silicone rubber or other resilient material and defines a closed loop 306 that attaches to tool holder 100 through left and right cord openings 134, 234. As shown in FIGS. 9-9A, cord member 300 has a front plate 312 and a back plate 314 spaced apart and aligned substantially parallel to each other. Cord 310 extends between and connects front plate 312 to back plate 314 as well as extending forward from front plate 312 to define loop 306. Cord 310 joins front plate 312 to back plate 314 at locations corresponding to left and right cord openings 134, 234. Cord member 300 optionally includes pull tab 305 to assist the user in stretching cord member 300 over left and right catches 129, 229 or to engage hanger member 400 in a stowed position. As discussed above, cord member 300 may have other shapes and configurations and be made of resilient or non-stretchable materials.

To install cord member on tool holder 100, holder body 108 is inserted partially between front plate 312 and back plate 314. Since cord member 300 is made of a resilient material, cord member 300 is then stretched to further pass holder body between front and back plates 312, 314 and to position cord 310 extending between them in left and right cord openings 134, 234. When installed as shown in FIG. 9A, front plate 312 and back plate 314 abut holder body 108.

Hanger member 400 is shaped to mate with body top portion 108a. In one embodiment, hanger member 400 includes a fastener opening 403 configured to align with opening 111 of tool holder 100 and receive a fastener 402 (shown in FIG. 9A) therethrough. As such, tool holder 100 is fixedly coupled to hanger member 400 in a fixed or movable position. One or more additional fastener openings 405 may be used to secure hanger member 400 to a tool belt 410 (shown in FIG. 1) or other support structure.

In one embodiment, hanger member 400 includes a cord catch 409 positioned to engage cord member 300 and retain it in a stowed position. In one embodiment, cord catch 409 extends forward from a top portion 400a of hanger member 400 and has an upwardly-facing recess or slot 411 configured to receive cord member 300 therein. In one embodiment, cord catch 409 is spaced sufficiently above left and right cord openings 134, 234 so as to require cord member 300 to be extended in tension or stretched to engage and hook over cord catch 409. When cord member 300 is made of resilient materials, being stretched to engage recess 411 maintains cord member 300 in a stowed position.

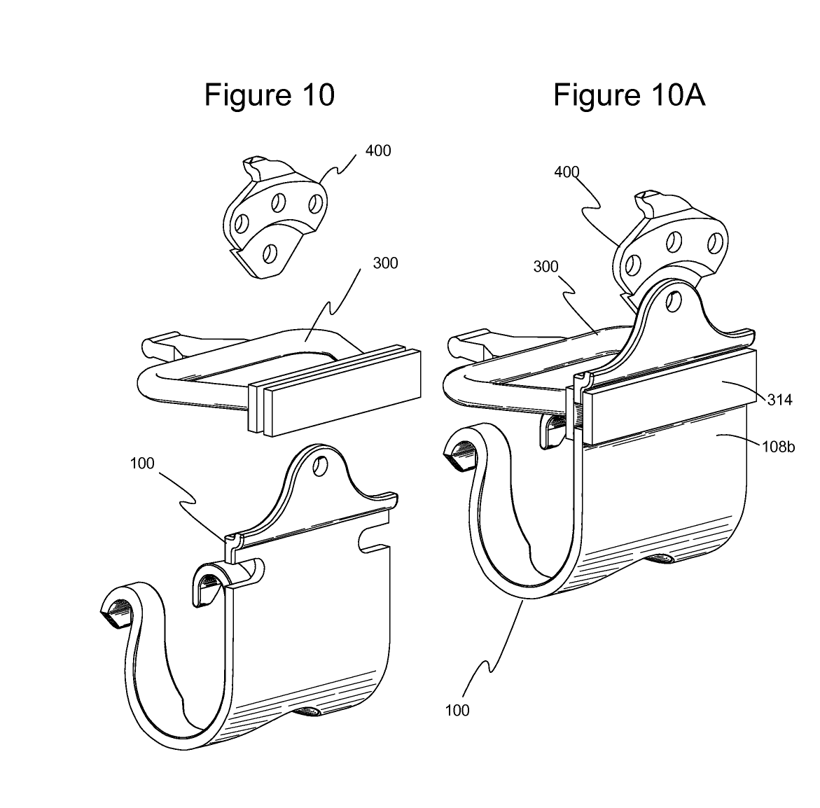

Referring now to FIGS. 10 and 10A, tool holder 100, cord member 300, and hanger member 400 of FIGS. 9-9A are illustrated in a left-side, rear perspective view. These components are shown separated in FIG. 10 and shown assembled in FIG. 10A. As shown in FIG. 10A, rear plate 314 of cord member 300 extends along a back surface 108b of holder body 108.

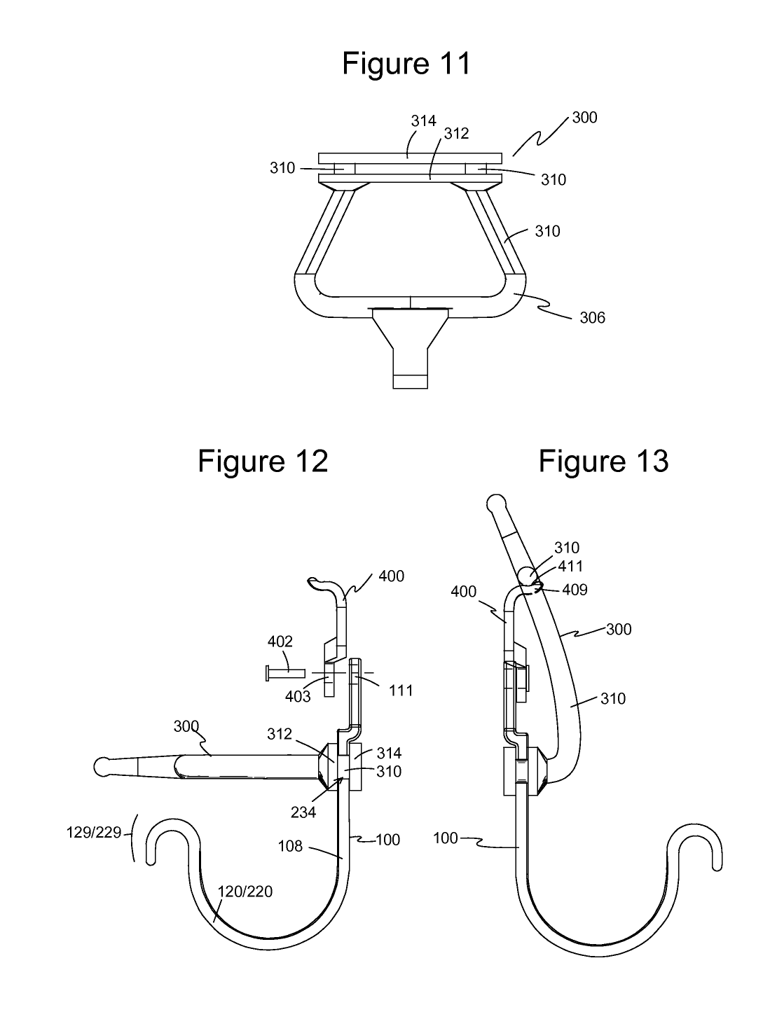

Referring now to FIG. 11, a top plan view illustrates cord member 300 of FIGS. 9-9A and 10-10A. Cord 310 connects front plate 312 to back plate 314, which are maintained with a spaced apart relationship to receive holder body therebetween. Cord 310 loops forward of front plate 312 to define loop 306. In some embodiments, loop 306 has a trapezoidal shape, which facilitates engagement of left and right catches 129, 229 on tool holder 100 (shown in FIGS. 9-10).

Referring now to FIG. 12, a left-side elevational view illustrates tool holder 100 of FIGS. 9-10 with cord member 300. Hanger member 400 is shown positioned adjacent body top portion 108a with fastener opening 403 aligned with opening 111 of tool holder 100. Cord member 300 is shown extending forward of holder body 108. Holder body 108 is located between front plate 312 and rear plate 314 of cord member 300 with cord 310 received in left and right cord openings 134, 234. Left and right catches 129, 229 as viewed from the side appear as a smaller inverted U shape connected continuously with a larger U shape of left and right holder arms 120, 220.

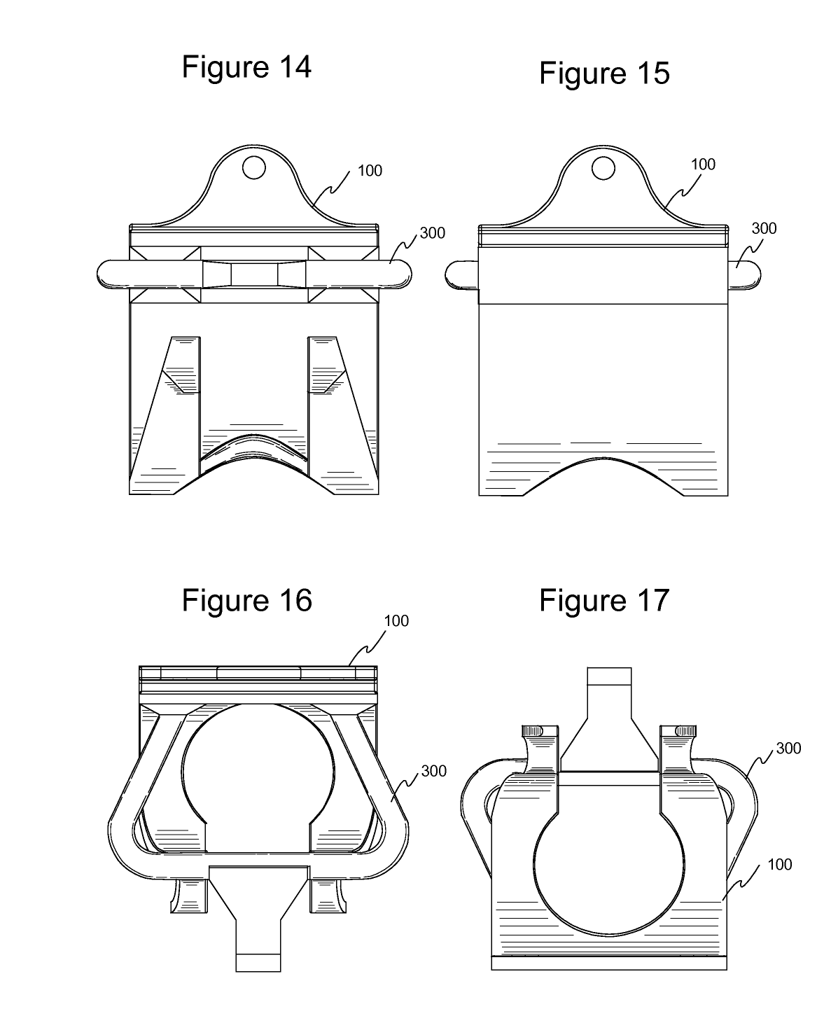

FIG. 13 illustrates a right-side elevational view of tool holder 100 with installed cord member 300 and coupled to hanger member 400. Cord member is shown in a stowed position with cord 310 received in slot 411 of cord catch 409. FIGS. 14-17 illustrate front elevational, rear elevational, top plan, and bottom plan views, respectively of tool holder 100 with cord member 300.

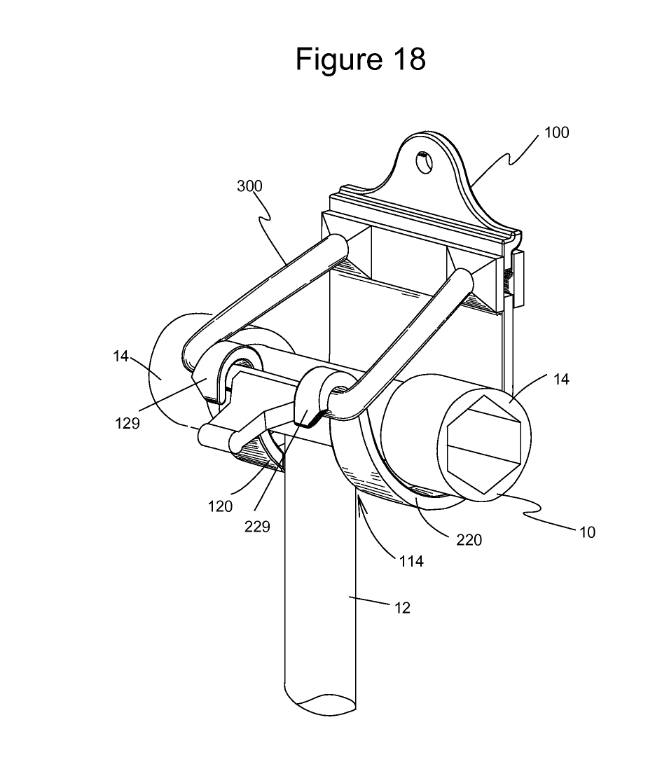

FIG. 18 illustrates a right side and front perspective view of tool holder 100 in use with tool 10. Tool head 14 is supported on left and right holder arms 120, 220 and handle 12 extends through tool opening 114. Cord member 300 extends from holder body 108 to engage left and right catches 129, 229.

In use, tool holder 100 is provided, where tool holder 100 has a left holder arm 120 and a right holder arm 220 extending forward in a spaced-apart relation from a holder body 108. Left and right holder arms 120, 220 generally define a U shape to support a T-shaped tool 10 with handle 12 extending vertically through tool opening 114 between left and right holder arms 120, 220. Tool holder 100 may be provided as part of a tool belt 410, harness, tool bag, or other item. In some instances, tool holder 100 is provided with a hanger member 400 in a ready-to-attach condition or already attached to another object.

To install a tool 10 into tool holder 100, the user inserts handle 12 down through tool opening 114 so that tool head 14 is supported on the U shape or J shape of left holder arm 120 and right holder arm 220. When tool has an attached tether 20, tether 20 may pass through gap 116 between left and right arm ends 132, 232. Since gap 116 communicates with tool opening 114, tether 20 may be passed through gap 116 to extend through tool opening 114 as needed during insertion of tool 10 into and removal of tool 10 out of tool holder 100.

Optionally, tool holder is selected to include cord member 300 secured through left and right cord openings 134, 234. When the user desires to more securely retain tool 10 in tool holder 100, cord member 300 may be stretched or extended over tool head 14 and hooked over left and right catches 129, 229 defined by left and right holder arms 120, 220. In doing so, cord member 300 is positioned to block egress of tool 10 from tool holder by extending over the top of tool head 14. To release tool 10, the user simply disengages cord member 300 from left catch 129 and right catch 229. If desired, and when hanger member is supplied with cord catch 409, cord member 300 optionally is positioned to engage cord catch 409 to retain cord member 300 in a stowed position. Optionally, cord member 300 is selected to include pull tab 305 to facilitate moving cord member 300 between positions where it engages left and right catches 129, 229 and when it is released or moved to a stowed position. For example, the user grasps pull tab 305 to facilitate hooking and unhooking cord member 300 from left and right catches 129, 229 defined by third left and right arm portions 128, 228, respectively.

By selecting and using tool holder 100 as discussed above, the user may avoid problems associated with prior art tool holders that do not contemplate its use with a tethered tool 10.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

We claim:

1. A tool holder for T-shaped tools having a handle and a tool head, the tool holder comprising:
a holder body;
a left holder arm extending forwardly from the holder body to a first arm end, the left holder arm generally defining a left U shape;
a right holder arm extending forwardly from the holder body to a second arm end, the right holder arm generally defining a right U shape,
wherein the right holder arm is spaced apart from the left holder arm to define a tool opening sized to accept a tool handle vertically therethrough with the tool head being supported by the left holder arm and the right holder arm, and wherein the left arm end and the right arm end are spaced apart from each other to define a gap communicating with the holder opening to permit ingress and egress of a lanyard attached to the tool handle.

2. The tool holder of claim 1
wherein the left holder arm comprises:
a first left arm portion extending laterally away from the holder midpoint;
a second left arm portion joined continuously with the first left arm portion at a left rear shoulder portion, the second left arm portion generally having a U shape and extending forward from the left rear shoulder portion; and
a third left arm portion joined continuously with the second left arm portion at a left forward shoulder portion, the third left arm portion extending generally laterally from the left forward shoulder portion to terminate at the left arm end, wherein the third left arm portion is spaced apart from the first left arm portion; and
wherein the a right holder arm comprises:
a first right arm portion extending laterally away from the holder midpoint in a direction generally opposite of the first left arm portion;
a second right arm portion joined continuously with the first right arm portion at a right rear shoulder portion, the second right arm portion generally having a U shape and extending forward from the right rear shoulder portion; and
a third right arm portion joined continuously with the second right arm portion at a right forward shoulder portion, the third right arm portion extending generally laterally from the right forward shoulder portion to terminate at the right arm end, wherein the third right arm portion is spaced apart from the first right arm portion.

3. The tool holder of claim 2, wherein the left rear shoulder portion defines a left rear cord opening and the right rear shoulder portion defines a right rear cord opening, and wherein the tool holder further comprises a cord member connected through the left rear cord opening and the right rear cord opening and defines a loop with an adjustable size.

4. The tool holder of claim 3, wherein the left rear shoulder portion and the right rear shoulder portion each have a spiral that defines the respective left rear cord opening and the right rear cord opening.

5. The tool holder of claim 4, wherein adjacent turns of the spiral a sufficiently spaced apart to permit passage of the cord member therebetween.

6. The tool holder of claim 3, further comprising a pull tab connected to the cord member.

7. The tool holder of claim 3, wherein the third left arm portion and the third right arm portion each defines a catch sufficient to engage and retain the cord member extending forward from the left rear cord opening and the right rear cord opening.

9. The tool holder of claim 1, further comprising:
a cord member attached to the holder body and defining a loop with an adjustable size; and
a left catch on the left holder arm; and
a right catch on the right holder arm;
wherein the left catch and the right catch are sized and configured to engage and retain the loop extending forward from the holder body.

10. The tool holder of claim 9, wherein the left catch is defined by the left holder arm turning from the U shape and extending downwardly to the left arm end and wherein the right catch is defined by the right holder arm turning from the right U shape and extending downwardly to the right arm end.

11. The tool holder of claim 1, wherein the left holder arm and the right holder arm are substantially symmetrical.

12. The tool holder of claim 1, wherein the holder body defines a left cord opening and a right cord opening, and wherein the cord member is attached to the holder body through the left cord opening and the right cord opening.

13. The tool holder of claim 12, further comprising a pull tab connected to the loop of the cord member.

14. The tool holder of claim 12, wherein the cord member is made of a resilient material.

15. The tool holder of claim 1 further comprising:
a hanger member configured to interface with the holder body;
a fastener coupling the holder body to the hanger member; and
a hanger catch on the hanger member configured to engage the loop and retain the cord member in a stowed position.

16. A method of storing a tethered T-shaped tool comprising:
providing a T-shaped tool with a handle extending transversely from a tool head, wherein the tool head defines a first tool head portion and a second tool head portion extending in generally opposite directions from each other, and wherein the tool includes a tether attached to the handle;
providing a tool holder having a holder body, a left holder arm and a right holder arm, wherein the left holder arm and the right holder arm each generally define a U shape and extend in a spaced-apart relation forward from the holder body to a respective left arm end and a right arm end, wherein the left holder arm and the right holder arm define a tool opening vertically through the tool holder, and wherein the left arm end and right arm end are spaced apart and define a fixed gap therebetween;
passing the tether through the fixed gap between the left arm end and the right arm end;
inserting the handle through the tool opening; and
placing the tool head on the left holder arm and the right tool holder arm, thereby supporting the tool by the tool holder.

17. The method of claim 16, wherein providing the tool holder further comprises:
selecting the tool holder to include a cord member connected through right and left cord openings defined by the tool holder and defining a loop of adjustable size; and
extending the loop forward from the right and left cord openings and over the right arm end and the left arm end; and
changing the adjustable size to retain the cord member extending forward over the tool head.

18. The method of claim 17, further comprising
disengaging the cord member from the right arm end and the left arm end;
lifting the tool upward through the tool opening; and
passing the tether out through the gap between the right arm end and the left arm end.

19. The method of claim 17, wherein the step of selecting the tool holder to include a cord member includes selecting the cord member made of a resilient material, wherein changing the adjustable size includes allowing the resilient material to assume a tightened state against the tool holder.

20. The method of claim 18, further comprising:
selecting the tool holder to include a hanger member having a cord catch configured to engage the cord member; and
positioning the cord member to engage the cord catch, thereby placing the cord member in a stowed position.
